(19) United States
(12) Patent Application Publication
(10) Pub. No.: US 2026/0252291 A1
(43) Pub. Date: Aug. 27, 2026

(54) DELIVERY SERVER DELIVERING LABEL DATA UPLOADED FROM SOURCE DEVICE AND PRINT SETTING TO DESTINATION DEVICE

(71) Applicant: BROTHER KOGYO KABUSHIKI KAISHA, Nagoya (JP)

(72) Inventor: Ryoji BAN, Kiyosu (JP)

(21) Appl. No.: 19/543,039

(22) Filed: Feb. 18, 2026

(30) Foreign Application Priority Data
Feb. 26, 2025 (JP) 2025-028994

(51) Int. Cl. G06F 3/12

(52) U.S. Cl. CPC G06F 3/126; G06F 3/1204; G06F 3/1222; G06F 3/1226; G06F 3/1236; G06F 3/1238; G06F 3/1253; G06F 3/1288

(57) ABSTRACT

A delivery server is connectable to a network. The delivery server includes: a controller. The controller is configured to perform receiving a specification of a print setting from a source device connected to the network. The print setting is specified based on capabilities of a printer. The controller is configured to perform receiving uploading of label data from the source device connected to the network. The controller is configured to perform storing the label data and the specified print setting in association with each other. The controller is configured to perform delivering, to a destination device connected to the network, the label data and the specified print setting associated with the label data.

### REFERENCE TO RELATED APPLICATIONS

This application claims priority from Japanese Patent Application No. 2025-028994 filed on February 26, 2025. The entire content of the priority application is incorporated herein by reference.

### BACKGROUND ART

A technique employing a delivery server to register and deliver label data is known in the art. For example, a system known in the art includes, on the server side, a personal computer for designing labels, a label database that stores label data of the labels, and a registration number database for assigning product numbers, while on the client side the system includes a personal computer for issuing labels, a printer, and a cutting plotter. The system on the server side and the system on the client side are connected to each other and are configured to perform an integrated process of designing, issuing, and cutting labels.

### SUMMARY

When label data stored on the delivery server is downloaded and printing based on the label data is performed, the client device that downloads the label data sets the printing parameters. However, depending on the printing parameters, the resulting printout may differ from the intended results of the person who has uploaded the label data, i.e., the creator of the label data.

In view of the foregoing, it is an object of the present disclosure to provide a technique that employs a delivery server to store and deliver label data, thereby reducing the likelihood of yielding unintended printing results for the person who has uploaded the label data.

In order to attain the above and other objects, according to one aspect, the present disclosure provides a delivery server. The delivery server is connectable to a network. The delivery server includes: a controller. The controller is configured to perform: receiving a specification of a print setting from a source device connected to the network. The print setting is specified based on capabilities of a printer. The controller is configured to perform: receiving uploading of label data from the source device connected to the network. The controller is configured to perform: storing the label data and the specified print setting in association with each other. The controller is configured to perform: delivering, to a destination device connected to the network, the label data and the specified print setting associated with the label data.

The delivery server having the above configuration receives, from a source device, uploading of label data and a specification of a print setting, stores the received label data and print setting in association with each other, and delivers, to a destination device, the label data and the print setting associated with the label data. Accordingly, when the destination device performs printing based on the delivered label data, the destination device can be expected to use the print setting delivered together with the label data, thereby increasing the likelihood that a printing result intended by the person who has uploaded the label data will be obtained.

According to another aspect, the present disclosure also provides a non-transitory computer-readable storage medium storing a set of computer-readable instructions for an information processing device. The information processing device is connectable to a network to which a delivery server is connectable. The delivery server is configured to store one or more sets of label data and one or more print settings corresponding to the one or more sets of label data. Each of the one or more sets of label data is stored in association with a corresponding one of the one or more print settings. The set of computer-readable instructions, when executed by a computer of the information processing device, causes the information processing device to perform: a designating process; a download process; a storing process; and a printing process. The designating process includes: designating a set of label data from among the one or more sets of label data stored on the delivery server. The download process includes: downloading, from the delivery server, the set of label data designated in the designating process and a print setting associated with the set of label data. The storing process includes: storing the set of label data and the print setting downloaded in the download process in association with each other. The printing process includes: transmitting a print command to a printer. The print command causes the printer to execute printing based on the set of label data stored in the storing process using the print setting stored in association with the set of label data.

A control method, an apparatus, a computer program such as a printing program, for realizing the functions of the delivery server described above, and a computer-readable storage medium storing such a computer program are also novel and useful.

The present disclosure realizes a technique that employs a delivery server to store and deliver label data, thereby reducing the likelihood of yielding unintended printing results for a person who has uploaded the label data.

### BRIEF DESCRIPTION OF DRAWINGS

FIG. 1 is a diagram illustrating a schematic configuration of a delivery system.

FIG. 2A is a diagram illustrating an example of the structure of records registered in a label database.

FIG. 2B is a diagram illustrating an example of the structure of records registered in a printer database.

FIG. 2C is a diagram illustrating an example of the structure of records registered in a settings database.

FIGS. 3A and 3B are sequence diagrams illustrating an example of the procedure of a print settings upload process.

FIG. 4A is a diagram illustrating an example of a home screen.

FIG. 4B is a diagram illustrating an example of a printer selection screen.

FIG. 4C is a diagram illustrating an example of a print settings registration screen.

FIG. 5 is a sequence diagram illustrating an example of steps in a label data upload process.

FIG. 6A is a diagram illustrating an example of an upload screen.

FIG. 6B is a diagram illustrating an example of a print settings specification confirmation screen.

FIG. 6C is a diagram illustrating an example of a print settings specification screen.

FIG. 7A is a sequence diagram illustrating an example of steps in a manual download process.

FIG. 7B is a sequence diagram illustrating an example of steps in a delivery process illustrated in FIG. 7A.

FIG. 8A is a sequence diagram illustrating an example of steps in an automatic download process.

FIG. 8B is a diagram illustrating an example of an automatic download settings screen.

FIG. 9 is a sequence diagram illustrating an example of steps in a printing process.

FIG. 10 is a flowchart illustrating an example of steps in a configuration process.

FIG. 11 is a flowchart illustrating another example of steps in the configuration process.

### DESCRIPTION

Next, a delivery server that delivers label data will be described while referring to the accompanying drawings. This embodiment discloses a delivery system including a delivery server, a source device, and a destination device that are connected to each other via a network. In this delivery system, the delivery server delivers label data, which has been uploaded to the delivery server from the source device, to the destination device.

### Overall Configuration of Delivery System

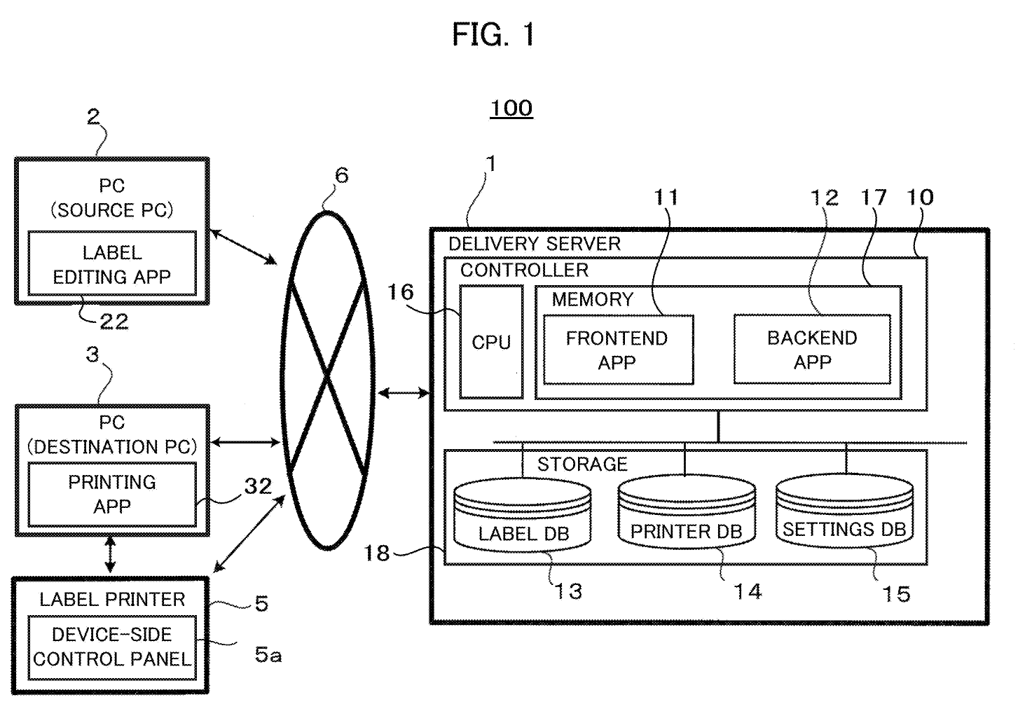

FIG. 1 illustrates a delivery system (hereinafter simply referred to as the “system”) 100. The system 100 includes a delivery server 1 that is connected to a network 6, such as the Internet. Personal computers (hereinafter abbreviated as “PCs”) 2 and 3 and a label printer 5 are connected to the delivery server 1 via the network 6 so as to be capable of communicating with the delivery server 1. The delivery server 1 is managed by the vendor of the label printer 5, for example. In the present embodiment, the delivery server 1 has a function for storing label data representing images of labels, and a function for delivering the stored label data.

As an example, the PC 3 and the label printer 5 are provided in a store, such as a supermarket. The label printer 5 has at least a communication function and a printing function. Although not illustrated in FIG. 1, the label printer 5 includes a controller that includes a CPU and a memory. The CPU executes various processes according to programs read from the memory. The memory stores various programs and various data, and is used as work areas when executing various processes. Buffers provided in the CPU is also an example of memory. Examples of the memory may be ROM, RAM, a hard disk drive, or the like built into the label printer 5, or may be any storage medium that is readable and writable by the CPU, such as CD-ROM or DVD-ROM. The CPU of the label printer 5 is an example of the computer of the present disclosure.

The label printer 5 also includes a device-side control panel 5a. The device-side control panel 5a includes operating parts that receive various operations specifying print settings, device-side print instructions to execute printing, for example. The device-side control panel 5a may include a display unit for displaying information based on data.

The label printer 5 can accommodate, for example, a roll-shaped continuous sheet and has functions for printing images on the sheet to produce labels. The roll-shaped sheet is a print medium in which a sheet is overlaid on a continuous strip of release paper and wound into a roll. The sheet may be a continuous elongated tape or may consist of die-cut labels that have been pre-cut into a predetermined shape. A cassette that accommodates the roll-shaped sheet is detachably mountable in the label printer 5.

A plurality of types of cassettes is mountable in the label printer 5. The various types of cassettes include cassettes that accommodate continuous elongated tape, cassettes that accommodate die-cut labels for price tags, and cassettes that accommodate die-cut labels for addresses. The sheets accommodated in these cassettes vary, for example, in text color, background color, sheet size, and material, depending on the cassette model. Sheet size includes the sheet width, which is the dimension of the sheet in a direction orthogonal to a conveying direction of the sheet, and the sheet length, which is the dimension of the sheet in the conveying direction of the sheet. The material may be paper, plastic, or cloth, for example. The label printer 5 of the present embodiment may also have functions for cutting and discharging the printed portion of the sheet after printing.

The PC 3 is connected to and capable of communicating with the label printer 5. Communication may be achieved through a wired or wireless method. Although not illustrated in FIG. 1, the PC 3 includes a controller that includes a CPU and a memory. The CPU executes various processes according to programs read from the memory. The memory stores various programs and various data, and is used as work areas when executing various processes. Buffers provided in the CPU is also an example of memory. Examples of the memory may be ROM, RAM, a hard disk drive, or the like built into the label printer 5, or may be any storage medium that is readable and writable by the CPU, such as CD-ROM or DVD-ROM. The CPU of the PC 3 is an example of the computer of the present disclosure.

A printing application program (hereinafter referred to as a “printing app”) 32 that controls printing by the label printer 5 is installed on the PC 3. The printing app 32 is an example of the set of computer-readable instructions of the present disclosure.

The printing app 32 is a program provided by the vendor of the label printer 5, for example. The printing app 32 can use services provided by the delivery server 1. Through the printing app 32, the PC 3 can download label data from the delivery server 1. According to the printing app 32, the PC 3 can also display a settings screen that receives print settings based on the capabilities of the label printer 5 and can receive print settings (specified print settings) through the settings screen. The printing app 32 can output a print command to the label printer 5 to execute printing based on label data downloaded from the delivery server 1, for example, using the print settings received via the settings screen. In the following description, the PC 3 will be referred to as the “destination PC 3.”

The label printer 5 may be connected to the delivery server 1 via the destination PC 3 or may be connected directly to the delivery server 1. Although FIG. 1 illustrates only one destination PC 3 and one label printer 5, in practice, multiple destination PCs 3 and multiple label printers 5 installed in various stores are connected to the delivery server 1.

The PC 2 is provided in a management company that manages the above stores, for example. A label editing application program (hereinafter referred to as a “label editing app”) 22 for editing label data is installed on the PC 2.

Although not illustrated in FIG. 1, the PC 2 includes a controller that includes a CPU and a memory. The CPU executes various processes according to programs read from the memory. The memory stores various programs and various data, and is used as work areas when executing various processes. Buffers provided in the CPU is also an example of memory.

Examples of the memory may be ROM, RAM, a hard disk drive, or the like built into the label printer 5, or may be any storage medium that is readable and writable by the CPU, such as CD-ROM or DVD-ROM.

The label editing app 22 is a program provided by the vendor of the label printer 5, for example. The label editing app 22 can use the services provided by the delivery server 1. Through the label editing app 22, the PC 2 can upload edited label data to the delivery server 1. According to the label editing app 22, the PC 2 can also upload print settings to be associated with the label data being uploaded to the delivery server 1. The process of uploading label data and print settings will be described later. In the following description, the PC 2 will be referred to as the “source PC 2.”

The printing app 32 and the label editing app 22 can connect to and communicate with the delivery server 1 via their own browser functions or via a browser possessed by the respective destination PC 3 and source PC 2. The browser possessed by the destination PC 3 or the source PC 2 may be incorporated in the operating system (hereinafter simply referred to as “OS”) of the corresponding destination PC 3 or source PC 2 or may be installed separately from the OS.

The source PC 2 is an example of the source device of the present disclosure. Each of the destination PC 3 and the label printer 5 is an example of the destination device of the present disclosure. The destination PC 3 is an example of the information processing device of the present disclosure. The label printer 5 is an example of the printer of the present disclosure. An example of the source device, the destination device, and the information processing device may be a smartphone or a tablet terminal.

### Configuration of the Delivery Server 1

The delivery server 1 has at least a communication function and a storage function. The delivery server 1 includes a controller 10 and a storage 18. The controller 10 and the storage 18 are connected to each other. Note that the controller 10 in FIG. 1 is a general concept that covers hardware and software used for controlling the delivery server 1 and is not actually limited to representing a single piece of hardware present in the delivery server 1.

The storage 18 stores databases including a label database 13 (denoted as “LABEL DB 13” in the drawings), a printer database 14 (denoted as “PRINTER DB 14” in the drawings), and a settings database 15 (denoted as “SETTINGS DB 15” in the drawings), for example. The label database 13, the printer database 14, and the settings database 15 are stored in the storage 18 provided within the delivery server 1 in the example of FIG. 1, but the databases may alternatively be implemented outside the delivery server 1.

The controller 10 includes a CPU 16 and a memory 17. The controller 10 is an example of the controller of the present disclosure. The CPU 16 in the delivery server 1 executes various processes according to programs read from the memory 17. The memory 17 stores various programs and various data, and is used as work areas when executing various processes. Buffers provided in the CPU 16 is also an example of memory. Examples of the memory 17 may be ROM, RAM, a hard disk drive, or the like built into the delivery server 1, or may be any storage medium that is readable and writable by the CPU 16, such as CD-ROM or DVD-ROM.

In the present embodiment, the memory 17 stores a frontend application program (hereinafter referred to as a “frontend app”) 11 and a backend application program (hereinafter referred to as a “backend app”) 12. The frontend app 11 and the backend app 12 work together to execute processes on the delivery server 1. Processes on the delivery server 1 may be executed by the CPU 16 according to a single application program. The delivery server 1 illustrated in FIG. 1 is configured of a single device, but the delivery server 1 may be configured of a system including multiple devices.

The frontend app 11 is not installed on an information processing device connected to the delivery server 1 but is a web application program that can be used via a web browser on the information processing device. The frontend app 11 has a function to provide screens that can be displayed in the browser for receiving user operations, for example. Various page information for displaying screens on the source PC 2 and the destination PC 3 are prepared in the frontend app 11.

The backend app 12 is a program that executes various processes in accordance with requests from the frontend app 11. Specifically, the backend app 12 can call various databases provided in the storage 18 to store and retrieve information. The databases accessible by the backend app 12 include the label DB 13, the printer DB14, and the settings DB 15, for example.

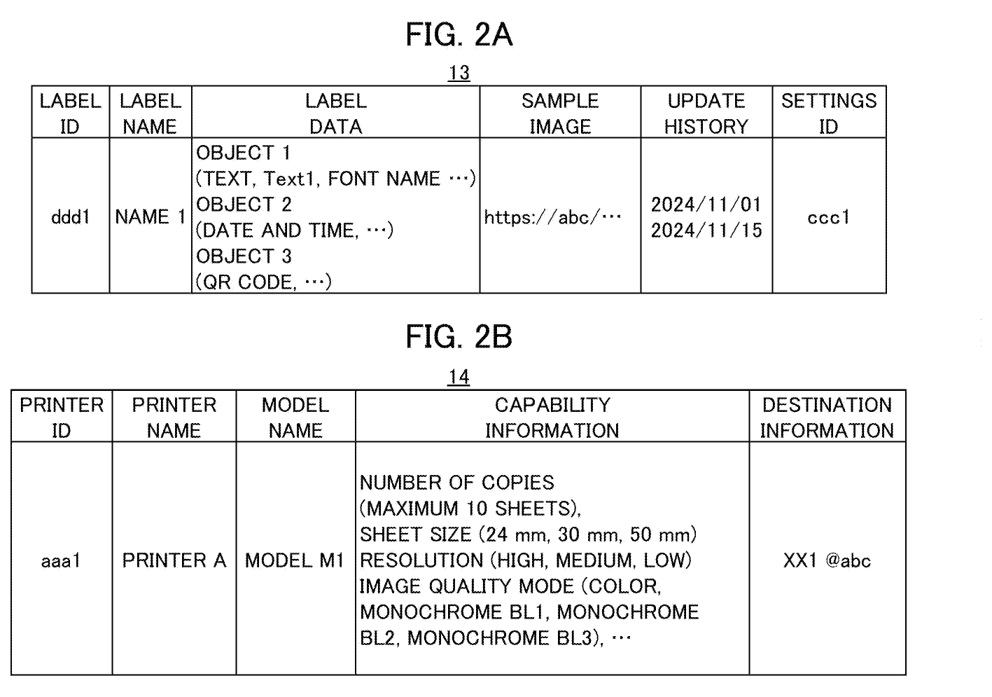

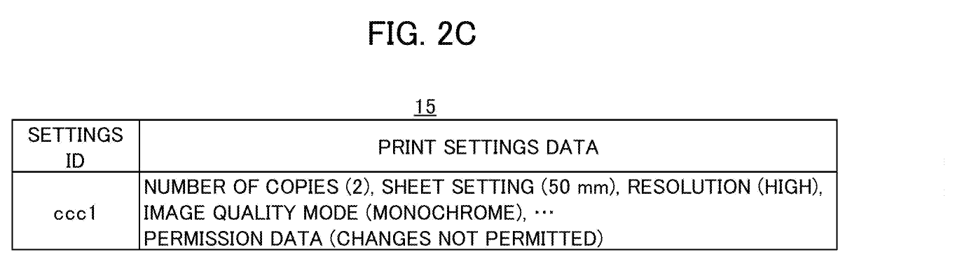

Label data uploaded from, for example, the source PC 2 is stored in the label database 13. FIG. 2A illustrates the structure of records registered in the label database 13. For each set of label data, the label database 13 stores therein a record that includes a field for a label ID (label ID field), a field for a label name (label name field), a field for label data (label data field), a field for a sample image (sample image field), a field for an update history (update history field), and a field for a settings ID (settings ID field).

The label ID field stores therein information identifying the label corresponding to the label data. The label name field stores therein the name of the label. The label data field stores therein the label data uploaded to the delivery server 1. Label data includes data specifying the type, the content, and the layout of each object arranged in the label corresponding to the label data. The sample image field stores therein a URL indicating the storage location of a sample image for the label. The update history field stores therein the update history for the label data. The settings ID field stores therein a settings ID for identifying print settings associated with the label data. This field is blank when the label data has not been associated with print settings. The process of associating print settings with label data will be described later.

The printer database 14 stores therein printer information on printers that have been selected and registered from among those printers connected to the network 6. FIG. 2B illustrates the structure of records registered in the printer database 14. For each printer, the printer database 14 stores therein a record that includes a field indicating a printer ID (printer ID field), a field indicating a printer name (printer name field), a field indicating a model name (model name field), a field indicating capability information (capability information field), and a field indicating destination information (destination information field).

The printer ID field stores therein information that identifies the printer, such as a serial number. The printer name field stores therein the name of the printer. The model name field stores therein a model name indicating the model of the printer. The capability information field stores therein information specifying the capabilities of the printer. The capability information field also stores therein setting values that can be set for each item of the print settings. The destination information field stores therein information specifying a destination of the printer, such as an IP address.

The settings database 15 stores therein print settings uploaded from, for example, the source PC 2. FIG. 2C illustrates the structure of records registered in the settings database 15. For each set of print settings, the settings database 15 stores therein a record that includes a field indicating a settings ID (settings ID field) and a field indicating print settings data (print settings data field). The settings ID field stores therein information identifying the print settings. The print settings data field stores therein print settings data specifying the uploaded print settings. The print settings data includes a setting value set for each item of the print settings. The print settings data includes permission data indicating whether the print settings can be changed.

### Description of Delivery Operation

A delivery operation performed on the system 100 will be described next. In the present embodiment, the description will be made using, as an example, a case in which the delivery server 1 delivers label data and print settings that an administrator has caused the source PC 2 to upload to the delivery server 1, to either the destination PC 3 or the label printer 5. The procedures and process steps of each program described below essentially indicate CPU processes performed according to instructions described in those programs. That is, each process with an action description such as “determine,” “set,” “obtain,” and “receive” represents a process performed by the CPU. Processes performed by the CPU include hardware control using the API in the OS of the device. However, a description of the role of the OS is omitted in this specification when describing the operations of programs. Note that the term “obtain” is used as a concept that does not necessarily require a request.

### Generating Label Data

First, operations for generating label data to be delivered (hereinafter also referred to as “target label data for delivery”) will be described. In A01 the administrator starts up the label editing app 22 on the source PC 2 and in A02 has the label editing app 22 generate the target label data for delivery.

Here, when a label editing instruction is received, the label editing app 22 displays a label editing screen (not illustrated) on the source PC 2. The label editing app 22 includes a plurality of objects that have been prepared in advance and arranges objects in the label editing screen in accordance with user operations. Examples of objects include text, images, borders, figures, barcodes, and QR codes. For example, the administrator has the label editing app 22 generate label data for a price tag by arranging objects in the label editing screen, including a text object indicating the product name, a text object indicating the selling price, and a barcode object representing a barcode that specifies a flag, a product price, and a product code. The label editing app 22 may use a database to write text and numerical values into the objects.

When a storage instruction is received, in A03 the label editing app 22 stores the edited label data on the source PC 2. At this time, the label data is saved (stored) in a first format. The first format is a file format capable of saving (storing) information used for editing the label data in addition to information used for executing printing based on the label data. Label data saved (stored) in the first format can be edited even after being saved (stored).

### Registering Printer

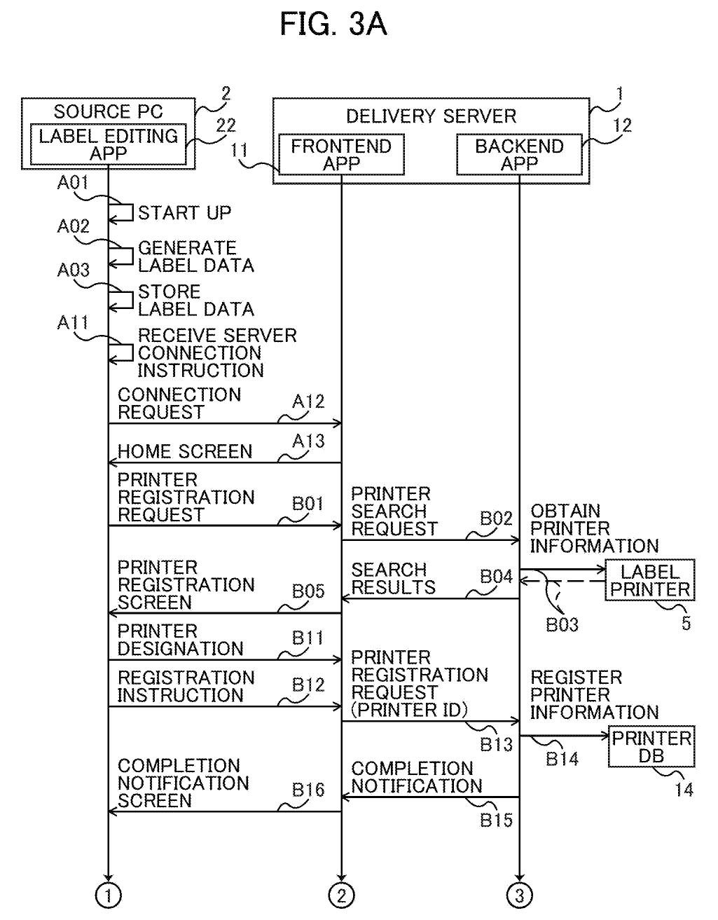

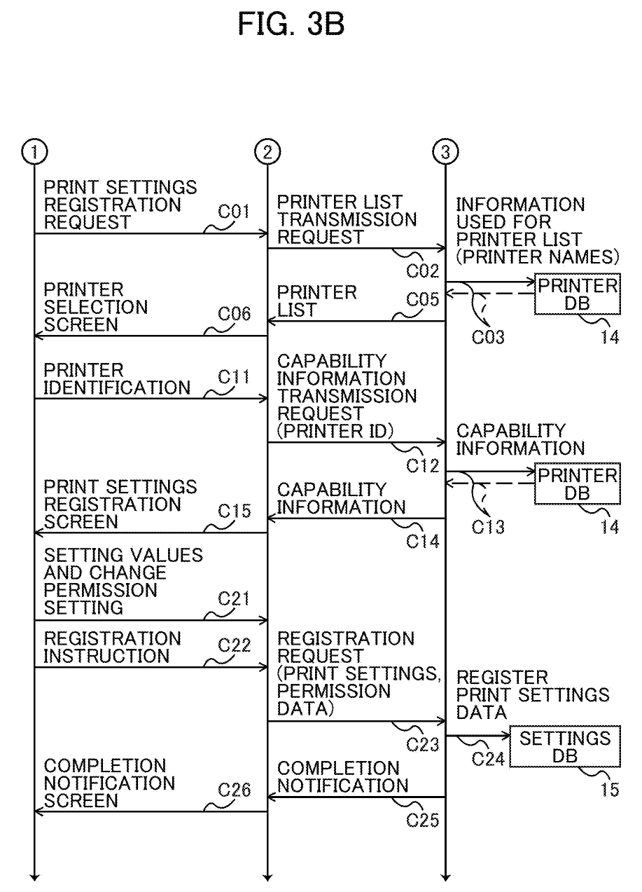

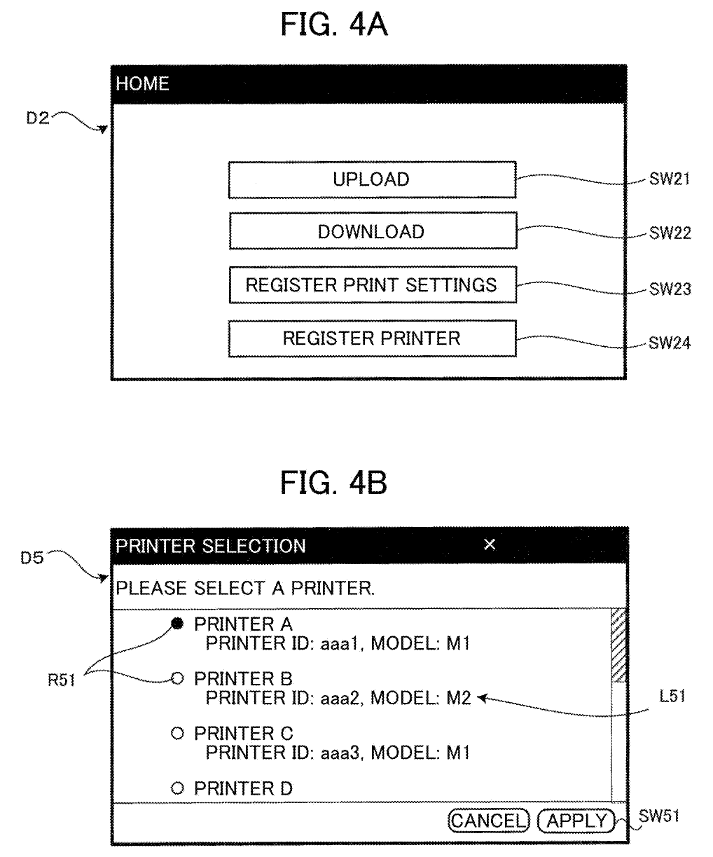

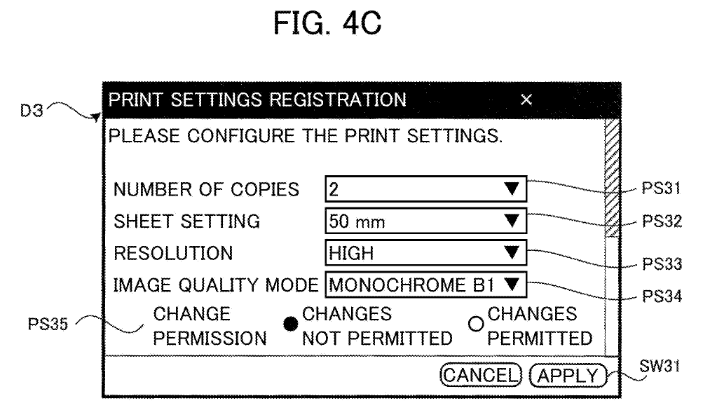

Next, operations for registering a printer will be described. In A11 of FIG. 3A, the source PC 2 receives an instruction to connect to the delivery server 1 (server connection instruction). Using a browser on the source PC 2 or a browser function of the label editing app 22, in A12 the source PC 2 issues a connection request to the delivery server 1 in order to establish a connection with the delivery server 1 so that the source PC 2 can communicate with the delivery server 1. Once the delivery server 1 is connected to the source PC 2, in A13 the frontend app 11 provides a home screen D2 to the source PC 2 to be displayed in the browser. FIG. 4A illustrates an example of the home screen D2. As illustrated in FIG. 4A, the home screen D2 includes an UPLOAD button SW21, a DOWNLOAD button SW22, a REGISTER PRINT SETTINGS button SW23, and a REGISTER PRINTER button SW24. To register a printer, the administrator operates the REGISTER PRINTER button SW24 on the source PC 2.

In response to this operation on the REGISTER PRINTER button SW24, in B01 the source PC 2 issues a printer registration request to the delivery server 1. Upon receiving the printer registration request, in B02 the frontend app 11 requests the backend app 12 to perform a printer search. In other words, in B02 the frontend app 11 issues a printer search request to the backend app 12. In B03 the backend app 12 searches for printers connected to the network 6 and obtains printer information including the printer ID from each of the connected printers. In B04 the backend app 12 passes the search results to the frontend app 11. In B05 the frontend app 11 provides a printer registration screen including the search results to the source PC 2.

In B11 the source PC 2 displays the printer registration screen (not illustrated), receives a designation of a printer from the administrator through the printer registration screen, and transmits information specifying the designated printer (printer designation) to the delivery server 1. In B12 the source PC 2 transmits an instruction to register the printer (registration instruction) to the delivery server 1. Upon receiving the printer designation and the registration instruction, in B13 the frontend app 11 requests the backend app 12 to register the designated printer in the printer database 14. In other words, in B13 the frontend app 11 issues a registration request to the backend app 12 to request registration of the designated printer in the printer database 14. The frontend app 11 passes the registration request, to which the printer ID is added, to the backend app 12. In B14 the backend app 12 updates the printer database 14 by registering printer information including the printer ID added to the registration request in the printer databases 14.

Once the printer information has been registered, in B15 the backend app 12 notifies the frontend app 11 that registration is complete (completion notification). In B16 the frontend app 11 provides a screen to the source PC 2 notifying the administrator of the source PC 2 that registration has been completed (completion notification screen).

In the present embodiment, the administrator designates a printer from among the printers the backend app 12 has retrieved in a search, but the backend app 12 may also receive user input of destination information through the frontend app 11 and designate a printer based on the inputted destination information. Furthermore, while label data is generated prior to registering a printer in the present embodiment, the printer may be registered first.

### Uploading Print Settings

Next, operations for uploading print settings to the delivery server 1 will be described. When the administrator operates the REGISTER PRINT SETTINGS button SW23 in the home screen D2 illustrated in FIG. 4A, in C01 of FIG. 3B the source PC 2 issues a request to register print settings (print settings registration request) to the delivery server 1. Upon receiving the print settings registration request, in C02 the frontend app 11 requests the backend app 12 to transmit a printer list. In other words, in C02 the frontend app 11 issues a printer list transmission request to the backend app 12.

In C03 the backend app 12 accesses the printer database 14 in response to the printer list transmission request and obtains information used for displaying the printer list from the printer database 14. In C05 the backend app 12 generates a printer list based on the information obtained from the printer database 14 and passes the printer list to the frontend app 11. In C06 the frontend app 11 provides a printer selection screen to the source PC 2, which includes the printer list received from the backend app 12. FIG. 4B illustrates an example of a printer selection screen D5.

In the example of FIG. 4B, the printer selection screen D5 includes a printer list L51, radio buttons R51, and an APPLY button SW51. The printer list L51 displays a printer name, a printer ID, and a model name for each printer. The radio buttons R51 indicate which one of the printers has been selected. The administrator operates the APPLY button SW51 in a state where one of the printers is selected via the radio buttons R51, for example.

In response to the operation on the APPLY button SW51, in C11 of FIG. 3 the source PC 2 identifies the printer selected via the radio buttons R51 and transmits information identifying the selected printer (printer identification) to the delivery server 1. Upon receiving the printer identification, in C12 the frontend app 11 requests the backend app 12 to transmit capability information for the selected printer. In other words, in C12 the frontend app 11 issues a capability information transmission request to the backend app 12. The frontend app 11 issues the capability information transmission request, to which the printer ID of the printer identified in C11 is added, to the backend app 12. In C13 the backend app 12 accesses the printer database 14 to obtain capability information associated with the printer ID added to the capability information transmission request. In C14 the backend app 12 passes the obtained capability information to the frontend app 11. By obtaining the capability information from the printer database 14 stored on the delivery server 1, the backend app 12 can obtain capability information for a selected printer, even when the selected printer is offline. As an alternative, the backend app 12 may read destination information associated with the printer ID from the printer database 14 and connect to the printer identified based on the destination information to obtain the capability information for the identified printer.

Once capability information has been received from the backend app 12, in C15 the frontend app 11 provides a print settings registration screen to the source PC 2. FIG. 4C illustrates an example of a print settings registration screen D3. The print settings registration screen D3 receives a setting value for each item of the print settings. The options for each item reflect the capability information received from the backend app 12. Therefore, print settings received via the print settings registration screen D3 are configured of setting values based on the capabilities of the selected printer.

The items of the print settings displayed in the print settings registration screen D3 may include some or all of the plurality of items that can be configured for the selected printer. In the present embodiment, the print settings registration screen D3 includes setting fields PS31, PS32, PS33, and PS34 for setting the number of copies, the sheet settings, the resolution, and the image quality mode. The number of copies required for a label may be determined according to the intended purpose of the label, as in the case of medical labels, for example. If the number of copies is arbitrarily set at the delivery destination, the destination printer might not print the number of copies required for some labels. Therefore, it is preferable to allow the user of the source PC 2 to specify the number of copies. Furthermore, if the sheet settings such as the sheet size, text color, and background color set during label editing differ from the sheet settings set in the print settings, the printing results may be defective or incomplete and deviate from the intended results. Therefore, it is preferable to allow the user to specify the sheet settings. Furthermore, some two-dimensional codes such as barcodes and QR codes (registered trademark) may not be legible when printed at less than a certain resolution. Therefore, it is preferable that the user be able to specify the resolution. In addition, multiple algorithms that can be used for binarizing data exist, and the printing results may differ in quality depending on the algorithm. Therefore, it is preferable to allow the user to specify the image quality mode. “QR code” is a registered trademark of DENSO WAVE INCORPORATED.

Note that the items of the print settings stored on the delivery server 1 may differ from the print settings described above in the present embodiment. The user need not be allowed to specify setting values for all print settings including the number of copies, the sheet settings, the resolution, and the image quality mode and, moreover, may be allowed to specify items other than the number of copies, the sheet settings, the resolution, and the image quality mode.

The print settings registration screen D3 also includes a change-permission field PS35 for specifying whether changes to the specified print settings are permitted. In the present embodiment, the change-permission field PS35 receives a specification indicating whether changes are permitted for the print settings as a whole. However, a separate change-permission field may alternatively be provided for each item of the print settings to receive a permission setting for the item.

As illustrated in FIG. 4C, the print settings registration screen D3 also includes an APPLY button SW31. The administrator operates the APPLY button SW31 after configuring the setting values for the respective items of the print settings displayed in the print settings registration screen D3 and specifying the change permission for the print settings in the change-permission field PS35.

In response to an operation on the APPLY button SW31, in C21 of FIG. 3 the source PC 2 transmits the setting values for the items of the print settings and the change permission setting configured in the print settings registration screen D3 to the delivery server 1 and in C22 transmits a registration instruction to the delivery server 1. After receiving the setting values and the registration instruction, in C23 the frontend app 11 requests the backend app 12 to register the print settings. In other words, in C23 the frontend app 11 issues a registration request to the backend app 12 to request registration of the print settings. The frontend app 11 issues the registration request, to which the setting values for the items of the print settings configured in the print settings registration screen D3 and the permission data configured through the change-permission field PS35 in the print settings registration screen D3 are added. The permission data indicates whether changes to the print settings are permitted.

Upon receiving the registration request to register print settings, in C24 the backend app 12 stores the print settings received from the frontend app 11 in the settings database 15. In this example, the backend app 12 generates a settings ID and stores a record including the generated settings ID in the settings database 15. The backend app 12 stores print settings data including the print settings and the permission data added to the registration request in the print settings data field of the newly-stored record. Once the print settings have been registered, in C25 the backend app 12 notifies the frontend app 11 that the uploading of print settings is complete (completion notification). In response to the completion notification received from the backend app 12, in C26 the frontend app 11 provides a screen to the source PC 2 notifying the administrator of the source PC 2 that the print settings have been uploaded (completion notification screen).

### Uploading Label Data

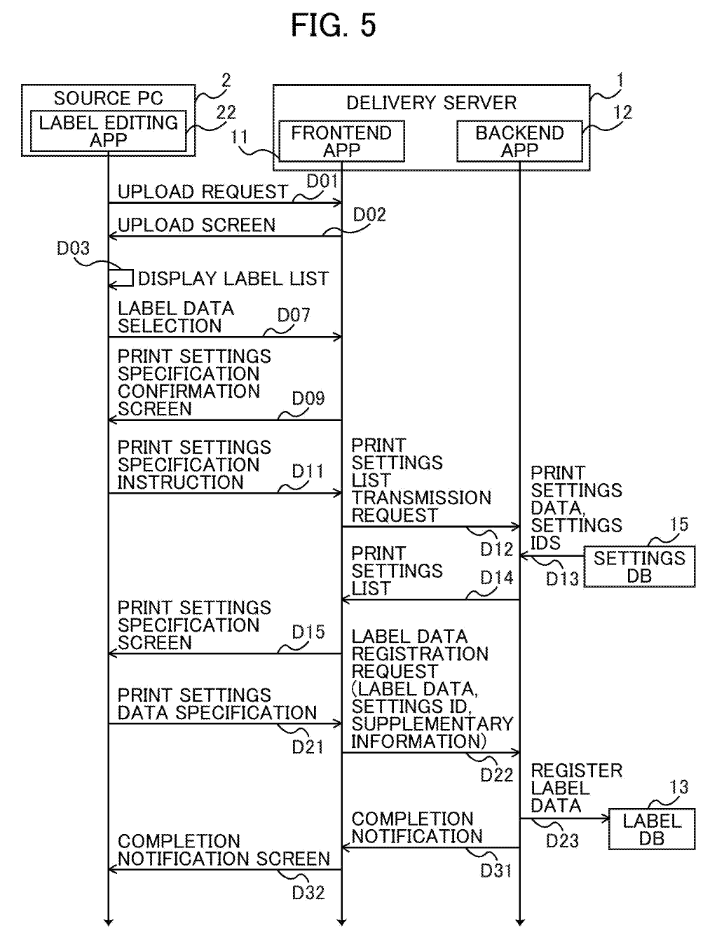

Next, operations for uploading label data to the delivery server 1 will be described. When the administrator operates the UPLOAD button SW21 in the home screen D2 illustrated in FIG. 4A, in D01 of FIG. 5 the source PC 2 issues an upload request to the delivery server 1. Upon receiving the upload request, in D02 the frontend app 11 provides an upload screen to the source PC 2. In D03 the source PC 2 displays the upload screen including a label list and receives user input.

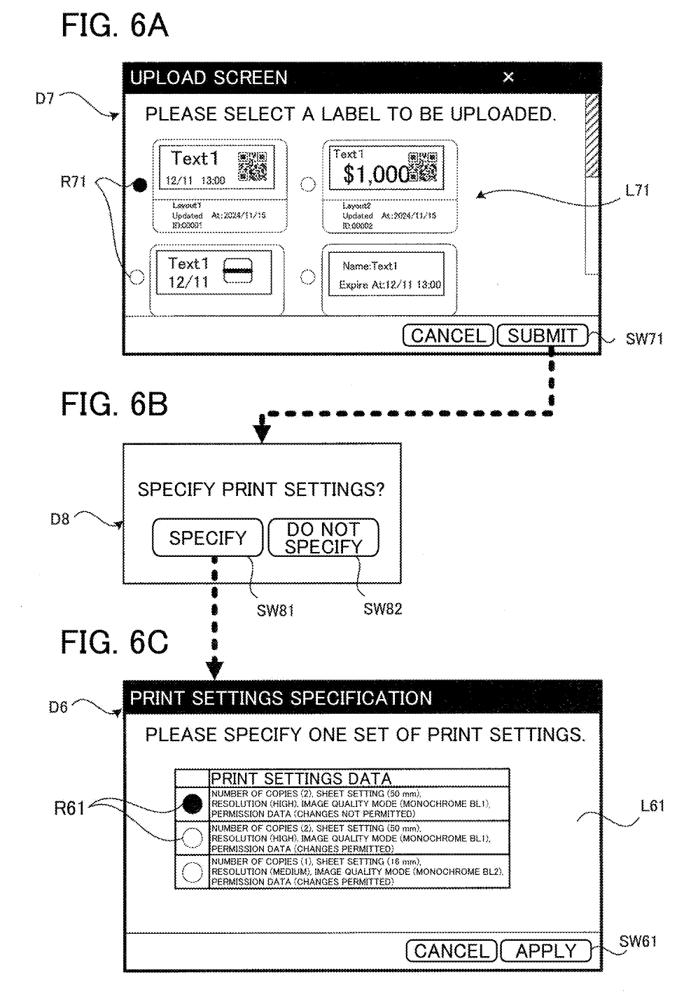

FIG. 6A illustrates an example of an upload screen D7 displayed on the source PC 2. The upload screen D7 displays a label list L71 based on the label data saved (stored) on the source PC 2. For example, a sample image may be displayed in the label list L71 for each set of label data. The label list L71 may also include, for example, information such as a label name, the last update, and a label ID for each set of label data. The label list L71 further displays a radio button R71 for each set of label data. The administrator selects one set of label data to be uploaded by selecting one of the radio buttons R71. The upload screen D7 may also receive input specifying supplementary information to be used in the label list, such as label names and sample images. After selecting a set of label data and inputting supplementary information, the administrator operates a SUBMIT button SW71 displayed in the upload screen D7.

In response to an operation on the SUBMIT button SW71, in D07 of FIG. 5 the source PC 2 submits information to the delivery server 1 indicating the label data selected in the upload screen D7 (label data selection). Upon receiving the label data selection, in D09 the frontend app 11 provides a print settings specification confirmation screen to the source PC 2. FIG. 6B illustrates an example of a print settings specification confirmation screen D8 displayed on the source PC 2 to confirm whether the user wishes to specify print settings. The print settings specification confirmation screen D8 includes a SPECIFY button SW81 indicating that the administrator wishes to specify the print settings, and a DO NOT SPECIFY button SW82 indicating that the administrator does not wish to specify the print settings. The administrator operates the SPECIFY button SW81 to specify print settings to be used by the destination device to which the label data is to be delivered.

In response to an operation on the SPECIFY button SW81, in D11 of FIG. 5 the source PC 2 receives an instruction to allow the specification of print settings (print settings specification instruction) and transmits the print settings specification instruction to the delivery server 1. Upon receiving the print settings specification instruction, in D12 the frontend app 11 requests the backend app 12 to transmit a print settings list. In other words, in D12 the frontend app 11 issues a print settings list transmission request to the backend app 12 to request transmission of a print settings list. Upon receiving the print settings list transmission request, in D13 the backend app 12 accesses the settings database 15 and reads the print settings data stored in the settings database 15 together with the settings IDs associated with the print settings data. In D14 the backend app 12 passes a print settings list for displaying a list of the read sets of print settings data to the frontend app 11. In D15 the frontend app 11 provides a print settings specification screen to the source PC 2. The print settings specification screen includes the print settings list received from the backend app 12.

FIG. 6C illustrates an example of a print settings specification screen D6 displayed on the source PC 2. The print settings specification screen D6 includes a print settings list L61 showing the print settings data for each set of print settings, for example. The print settings specification screen D6 also includes radio buttons R61, one arranged for each set of print settings. Each radio button R61 is associated with a settings ID. After selecting one of the sets of print settings data through the corresponding radio button R61, the administrator operates an APPLY button SW61.

In response to an operation on the APPLY button SW61, in D21 of FIG. 5 the source PC 2 transmits a specification (print settings data specification) to the delivery server 1 indicating the print settings data selected via the radio buttons R61. Upon receiving the print settings data specification, in D22 the frontend app 11 requests the backend app 12 to register the label data. In other words, in D22 the frontend app 11 issues a label data registration request to the backend app 12. The frontend app 11 issues the label data registration request, to which the label data selected in D07 and the settings ID associated with the print settings data specified in D21 are added. When supplementary information such as a label name or a sample image is received through the upload screen D7, the frontend app 11 also adds the supplementary information to the label data registration request.

After receiving the label data registration request, in D23 the backend app 12 accesses the label database 13 and registers the label data uploaded from the source PC 2 in the label database 13. For example, the backend app 12 generates a label ID and stores a record including the generated label ID in the label database 13. The backend app 12 then stores the label data added to the label data registration request in the label data field of the newly-stored record. The backend app 12 also stores the settings ID added to the label data registration request in the settings ID field of the record. The backend app 12 stores the label name in the label name field of the record and stores the URL information indicating the storage destination of the sample image included in the supplementary information in the sample image field of the record. The backend app 12 further stores the registration date in the update history field of the record.

Note that the backend app 12 may save (store) the label data in the label database 13 in its uploaded file format (the first format) or may convert the label data to the second format before saving (storing) the label data in the label database 13. The second format is a file format in which information not used for printing is eliminated and which is not editable. Thus, label data can be converted from the first format to the second format but cannot be converted from the second format back to the first format.

After the label data has been registered, in D31 the backend app 12 notifies the frontend app 11 that registration of the label data is complete (completion notification). In D32 the frontend app 11 provides a screen to the source PC 2 notifying the administrator of the source PC 2 that the uploading of the label data has been completed (completion notification screen).

By having the backend app 12 store the settings ID in the settings ID field of the record in the label database 13, the uploaded label data can be associated with the specified print settings. On the other hand, when the administrator operates the DO NOT SPECIFY button SW82 in the print settings specification confirmation screen D8 provided by the frontend app 11, the delivery server 1 skips the process in D11 through D21 and registers the label data selected in the upload screen D7 in the label database 13. In this case, the registered label data is not associated with any print settings data because the settings ID field in the record corresponding to the registered label data is left blank.

### Manually Downloading Label Data

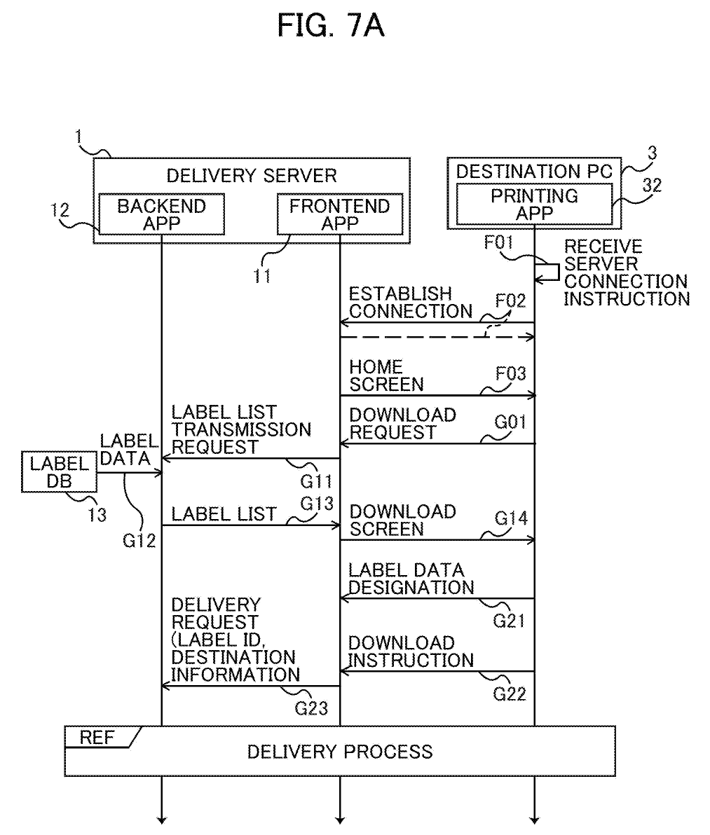

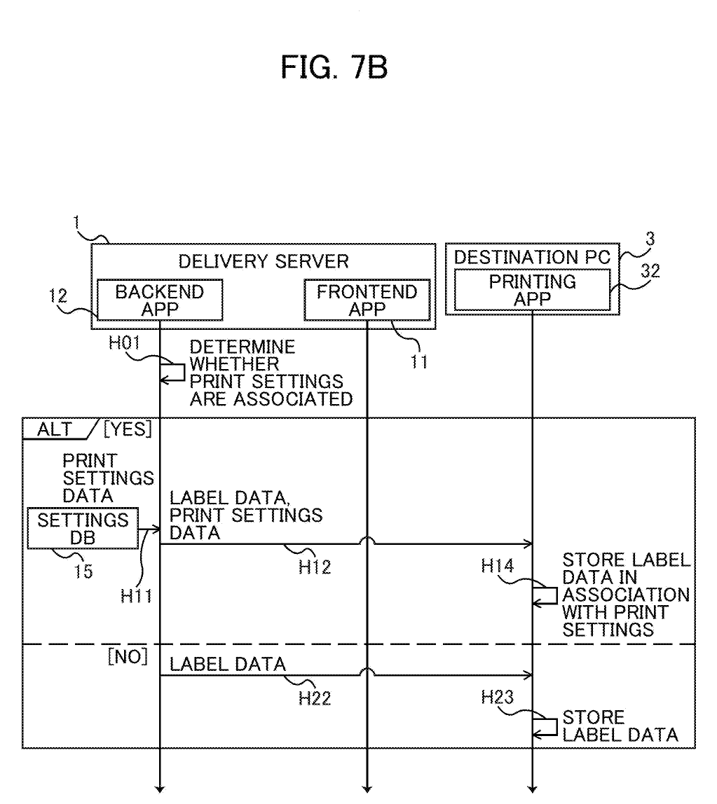

Next, operations for delivering label data will be described. First, the operations performed when the user of the destination PC 3 manually downloads label data will be described. As illustrated in FIG. 7A, in F01 the destination PC 3 receives a user instruction to connect to the delivery server 1 (server connection instruction). Upon receiving the server connection instruction, in F02 the destination PC 3 establishes a connection with the delivery server 1 using either a browser function of the printing app 32 or a browser installed on the destination PC 3. In F03 the frontend app 11 in the delivery server 1 provides the home screen D2 illustrated in FIG. 4A to the destination PC 3. Specifically, the frontend app 11 transmits data for displaying the home screen D2 to the destination PC 3.

When the DOWNLOAD button SW22 in the home screen D2 is operated, in G01 the destination PC 3 issues a download request to the delivery server 1. Upon receiving the download request, in G11 the frontend app 11 requests the backend app 12 to transmit a label list. In other words, in G11 the frontend app 11 issues a label list transmission request to the backend app 12. After receiving the label list transmission request from the frontend app 11, in G12 the backend app 12 reads the label data from the label database 13. In G13 the backend app 12 generates a label list based on the label data read from the label database 13 and passes the generated label list to the frontend app 11. Upon receiving the label list, in G14 the frontend app 11 provides a download screen including the label list to the destination PC 3.

After selecting one set of label data from the label list displayed in the download screen, the user of the destination PC 3 operates an APPLY button in the download screen. Upon receiving an operation on the APPLY button in the download screen, in G21 the printing app 32 receives a designation of the label data selected to be downloaded and transmits the designation to the delivery server for the selected label data (label data designation). In G22 the printing app 32 also transmits a download instruction to the delivery server 1. Upon receiving the label data designation and the download instruction, in G23 the frontend app 11 requests the backend app 12 to deliver the label data. In other words, in G23 the frontend app 11 issues a delivery request for the designated label data to the backend app 12. The frontend app 11 issues the delivery request, to which the label ID of the designated label data and the destination information for the destination PC 3, which is the source of the download request, are added. After receiving the delivery request, the backend app 12 performs a delivery process to control the delivery server 1 to deliver the designated label data to the source of the delivery request. The process of G21 is an example of the designating process of the present disclosure. The download instruction is an example of the delivery request of the present disclosure.

Here, the delivery process will be described with reference to FIG. 7B. Upon receiving a delivery request, in H01 the backend app 12 determines whether any print settings are associated with the label data to be downloaded (hereinafter also referred to as “target label data for download”). For example, the backend app 12 determines that print settings are associated with the target label data for download when a settings ID is associated with the target label data for download. When associated print settings exist (alt: YES), in H11 the backend app 12 reads from the settings database 15 the record that includes the settings ID associated with the target label data for download, and obtains the corresponding print settings data. In H12 the backend app 12 delivers the target label data for download together with the print settings data obtained from the settings database 15 to the destination PC 3, which is the source of the download request, according to the destination information added to the delivery request received in G23 of FIG. 7A. The backend app 12 may alternatively deliver the target label data for download to the destination PC 3 via the frontend app 11.

Once the printing app 32 of the destination PC 3 has received the label data and the print settings data from the delivery server 1 in H12, in H14 the printing app 32 stores the label data in association with the print settings. The process of H13 is an example of the download process of the present disclosure. The process of H14 is an example of the storing process of the present disclosure.

On the other hand, when no print settings ID is associated with the target label data for download, the backend app 12 determines in H01 that no print settings are associated with the target label data for download. When no associated print settings exist (alt: NO), in H22 the backend app 12 delivers only the target label data for download to the destination PC 3, which is the source of the download request, according to the destination information added to the delivery request received in G23 of FIG. 7A. The backend app 12 may alternatively deliver the target label data for download to the destination PC 3 via the frontend app 11. In H23 the print app 32 of the destination PC 3 stores the received label data.

Hence, when the target label data for download is associated with print settings, the destination PC 3 can download and store the associated print settings together with the label data.

### Automatically Downloading Label Data

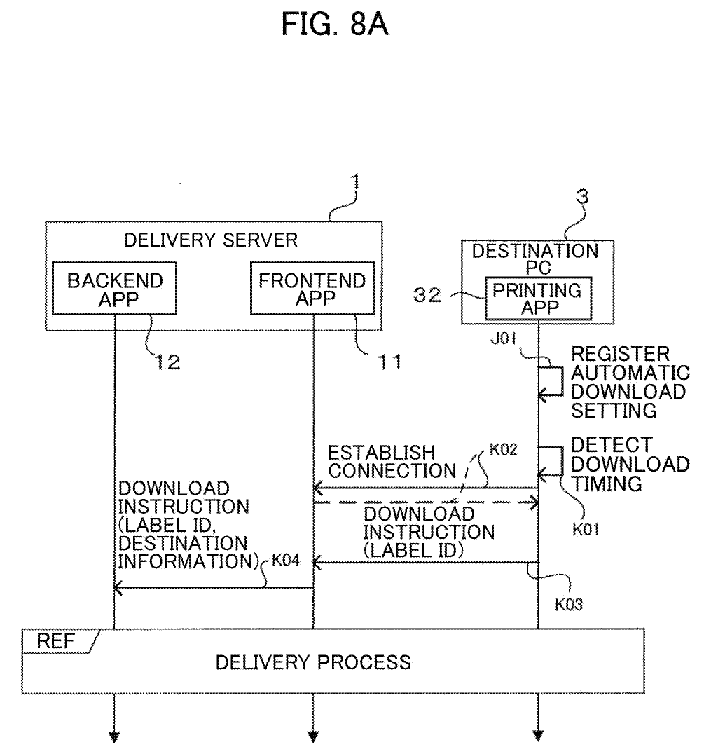

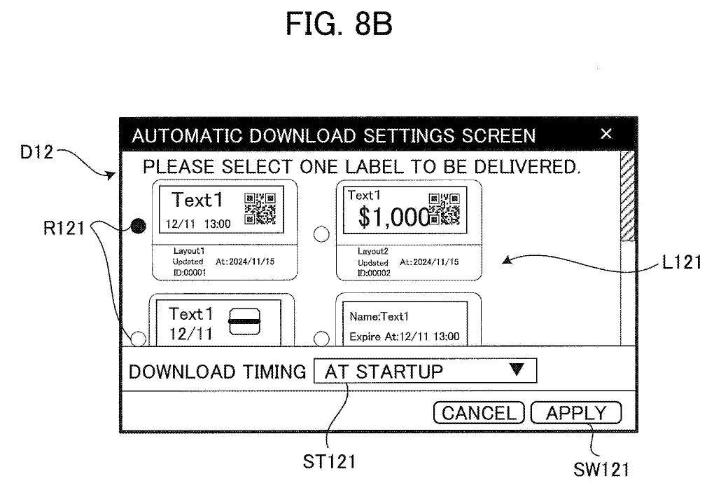

Next, operations in which the destination PC 3 automatically downloads label data will be described. As illustrated in FIG. 8A, in J01 the user of the destination PC 3 registers in advance a setting on the printing app 32 for automatically downloading label data (automatic download setting).

Specifically, the printing app 32 displays an automatic download settings screen D12 illustrated in the example of FIG. 8B on the destination PC 3. The printing app 32 connects to the delivery server 1, obtains a list of the label data stored on the delivery server 1, and displays a label list L121 based on the obtained list of the label data in the automatic download settings screen D12. The automatic download settings screen D12 includes a radio button R121 for each set of label data. The automatic download settings screen D12 also includes a download timing field ST121 for setting the timing to automatically transmit a download instruction. Examples of timings for automatically transmitting download instructions are a preset timing, such as when the printing app 32 is started up, or a periodic timing, such as every few hours.

When the user of the destination PC 3 operates an APPLY button SW121 in the automatic download settings screen D12 in a state where one set of label data is selected from the label list L121 and a timing for automatically transmitting a download instruction (download timing) is set in the download timing field ST121, the printing app 32 receives a designation of the target label data for download and the download timing and stores the received information in a storage area of the destination PC 3 provided for the printing app 32. The process of receiving the designation of label data via the automatic download settings screen D12 is an example of the designating process of the present disclosure.

When the printing app 32 detects in K01 that the download timing set through the download timing field ST121 has been reached, in K02 of FIG. 8A the printing app 32 connects to the frontend app 11 and in K03 the printing app 32 automatically transmits a download instruction to the frontend app 11. The printing app 32 transmits the download instruction to which the label ID for the label data specified in J01 is added. The automatically transmitted download instruction is an example of the delivery request of the present disclosure. In K04 the frontend app 11 passes to the backend app 12 the download instruction to which the label ID added to the download instruction and the destination information for the destination PC 3 that has transmitted the download instruction are added. When the backend app 12 receives the download instruction, the delivery server 1 executes a delivery process. Since the delivery process is executed similarly to the delivery process described above with reference to FIG. 7B, a detailed description of the delivery process will be omitted.

Therefore, when the target label data for download is associated with print settings, the printing app 32 can automatically download the associated print settings together with the label data and overwrite any stored data to update the stored data to the latest label data and print settings.

As with the printing app 32, the label printer 5 may also manually or automatically download label data and print settings from the delivery server 1 and store the downloaded label data and print settings in association with each other. In other words, the delivery server 1 may directly deliver the label data and the print settings to the label printer 5 in response to a delivery request from the label printer 5.

In the present embodiment, the delivery server 1 delivers label data and print settings in response to a delivery request from the destination PC 3 or the label printer 5. However, the delivery server 1 may alternatively push deliver label data and print settings to a predetermined destination device. In push delivery, for example, the delivery server 1 receives and registers a designation of the label data to be push delivered, destination information for the destination device, and a specification of the timing for push delivery (push delivery timing). When the delivery server 1 detects that the specified push delivery timing has been reached, the delivery server 1 executes the delivery process of FIG. 7B to deliver the label data designated as the target of push delivery and the print settings associated with the designated label data to the destination PC 3 or the label printer 5 according to the specified destination information.

### Printing Label Data

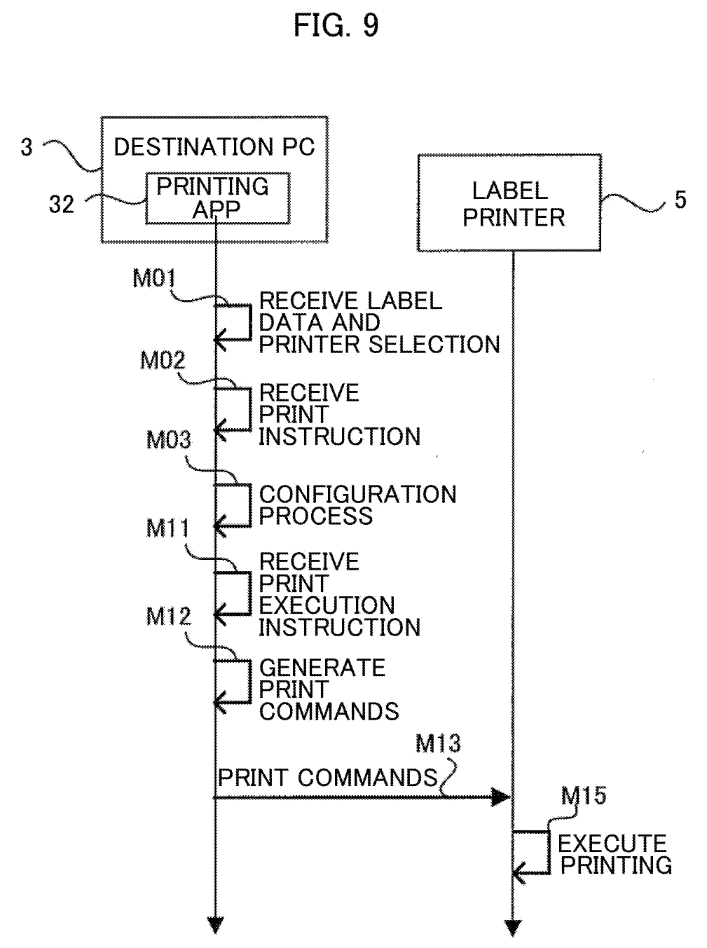

Next, operations performed when the printing app 32 controls the label printer 5 to execute printing based on label data downloaded from the delivery server 1 will be described. As illustrated in FIG. 9, in M01 the printing app 32 receives selections for the label data to be printed (hereinafter also referred to as “target label data for printing”) and the label printer 5 to execute printing (label data and printer selection). Once a print instruction is received in M02 after the label data and printer selection is received in M01, in M03 the print app 32 executes a configuration process. In the configuration process, the printing app 32 displays a settings screen for receiving print settings and receives print settings through the settings screen.

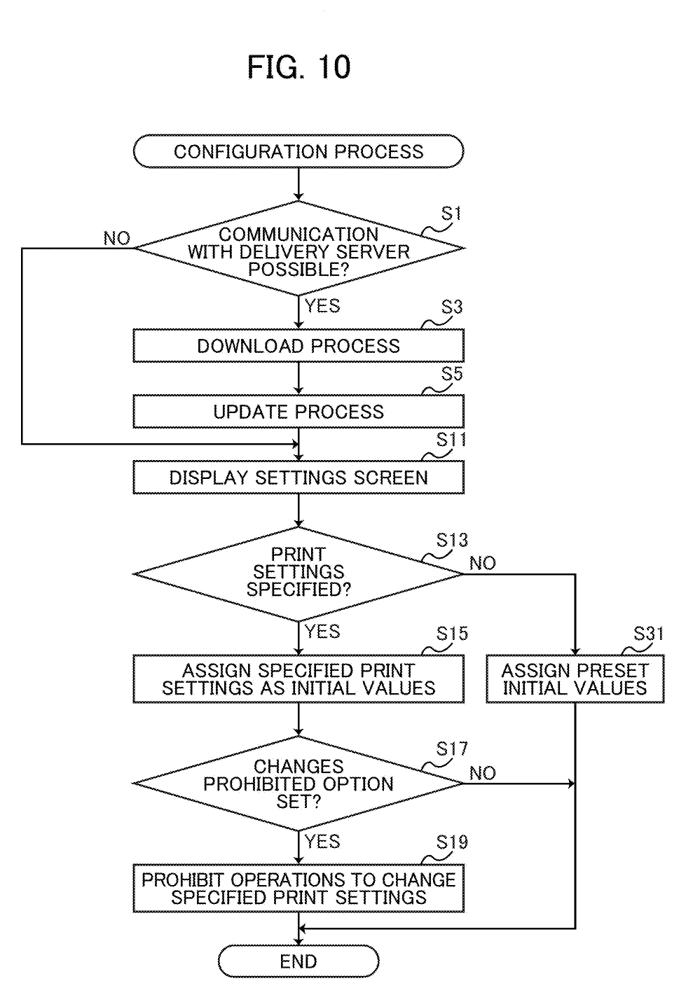

The configuration process will be described here with reference to FIG. 10. In S1 the printing app 32 first determines whether communication with the delivery server 1 is possible. When the printing app 32 can communicate with the delivery server 1 (S1: YES), in S3 the printing app 32 controls the destination PC 3 to execute a download process for downloading from the delivery server 1 the target label data for printing and the print settings data associated with the target label data for printing. In S5 the printing app 32 controls the destination PC 3 to execute an update process for updating the target label data for printing and the print settings data associated with the target label data for printing with the downloaded label data and print settings data. As a result, even when the administrator updates the target label data for printing or the print settings after the target label data for printing and the print settings data have been delivered to the destination PC 3, the updates will be reflected in the label data and the print settings used for printing. This action increases the likelihood of obtaining the printing results intended by the administrator.

On the other hand, when the printing app 32 is unable to communicate with the delivery server 1 (S1: NO), the printing app 32 skips the process in S3 and S5 and advances to S11. In other words, the printing app 32 does not download label data and print settings data from the delivery server 1. The process also advances to S11 following the completion of S5.

In S11 the printing app 32 displays a settings screen on the destination PC 3 for receiving print settings. In S13 the printing app 32 determines whether print settings have been specified. The printing app 32 determines that print settings have been specified when print settings have been stored in association with the target label data for printing. When print settings have been specified (S13: YES), in S15 the printing app 32 place the specified print settings as initial values. In other words, the printing app 32 assigns the setting values included in the specified print settings as initial values of the corresponding items among the items displayed in the settings screen. When the settings screen includes items not among the items of the specified print settings, the printing app 32 places initial values that have been preset for those items.

Following the process of S15, in S17 the printing app 32 determines whether an option specifying that changes to the specified print settings are not permitted, i.e., an option specifying that changes to the specified print settings are prohibited has been set. When the print settings data associated with the label data includes permission data indicating that changes are prohibited, the printing app 32 determines that an option specifying that changes to the specified print settings are prohibited has been set. When the option specifying that changes are prohibited has been set (S17: YES), in S19 the printing app 32 prohibits operations to change the specified print settings and ends the configuration process. As an example, the printing app 32 grays out items of the specified print settings and does not receive input through those items. This allows the printing app 32 to receive setting values for items other than the specified print settings while maintaining the setting values for the items of the specified print settings.

When the print settings data associated with the label data does not include permission data indicating that changes are not permitted, the printing app 32 determines that the option specifying that changes to the specified print settings are prohibited has not been set. When the option specifying that changes are prohibited has not been set (S17: NO), the printing app 32 skips S19 and ends the configuration process. Thus, the printing app 32 is permitted to change print settings, including the specified print settings. Since setting values included in the specified print settings are placed in the settings screen as initial values for the corresponding items of the specified print settings, the specified print settings can be used to execute printing based on the label data as long as the setting values remain changed.

On the other hand, when print settings have not been stored in association with the target label data for printing, the printing app 32 determines that no print settings have been designated. When no print settings have been specified (S13: NO), in S31 the printing app 32 assigns the preset initial values to all setting items in the settings screen and subsequently ends the configuration process.

Returning to FIG. 9, once a print execution instruction is received in M11, in M12 the printing app 32 uses the print settings set in the settings screen to generate print commands for executing printing based on the label data. The printing app 32 can generate print commands for executing printing based on the label data using the print settings associated with the label data, as long as the setting values for the specified print settings have not been changed.

In M13 the printing app 32 outputs the generated print commands to the label printer 5. The process of M13 is an example of the printing process of the present disclosure. In M15 the label printer 5 executes printing based on the label data according to the print commands received from the destination PC 3. When the print commands instruct the label printer 5 to execute printing based on the label data using the print settings associated with the label data, the label printer 5 executes the printing according to the specified print settings. Thus, this process can be expected to yield printing results in line with the administrator’s intentions.

When the label printer 5 receives label data and print settings data directly from the delivery server 1 and stores the label data and the print settings in association with each other, the label printer 5 can subsequently receive a designation of label data and device-side print instructions via the device-side control panel 5a. In such cases, the label printer 5 executes printing based on the designated label data using the print settings associated with the label data. Thus, as with the printing app 32, the label printer 5 can be expected to yield printing results in line with the administrator’s intention.

As described above, the delivery server 1 of the above embodiment receives the uploading of label data from the source PC 2, receives the specification of print settings from the source PC 2, stores the label data and the specified print settings in association with each other, and delivers the label data and the specified print settings associated with the label data to the destination PC 3 or the label printer 5. As a result, when the destination PC 3 or the label printer 5 executes printing based on the delivered label data, the destination PC 3 or the label printer 5 can be expected to use the specified print settings delivered together with the label data, thereby improving the possibility of yielding printing results intended by the administrator who has uploaded the label data.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the layout and the content of screens in the above description are not limited to the above embodiment.

For example, the delivery server 1 may be configured to perform only push deliveries. However, when the delivery server 1 receives a delivery request from the destination PC 3 or the label printer 5 to deliver designated label data, by delivering the designated label data together with the print settings associated with the designated label data, the destination PC 3 or the label printer 5 from which the delivery request has been received can be expected to use the print settings delivered together with the designated label data when issuing a print command for executing printing based on the designated label data.

For example, the delivery server 1 may not be configured to deliver label data directly to the label printer 5. However, by having the delivery server 1 deliver label data stored in the label database 13 and print settings associated with the label data to a selected label printer 5, the selected label printer 5 can be expected to execute printing based on the label data using the specified print settings.

For example, the change-permission field PS35 may be omitted from the print settings registration screen D3, and permission data may be omitted from the print settings data delivered in association with the label data. However, by having the delivery server 1 receive a specification indicating whether changes to the specified print settings are permitted together with the specification of the print settings and deliver permission data indicating whether changes to the specified print settings are permitted to the destination PC 3 or the label printer 5 together with the label data and the specified print settings, the destination PC 3 or the label printer 5 can be expected to restrict the changes to the specified print settings.

In the process for uploading label data described in FIG. 5 of the above embodiment, for example, the label data is associated with print settings data by registering the label data in the label database 13 in association with a settings ID in D23. However, the delivery server 1 may also store association data associating label IDs with settings IDs in a predetermined storage area rather than registering label data in the label database 13 in association with a settings ID.

In the above embodiment, for example, label data and print settings data are stored on the delivery server 1 as separate files. However, the source PC 2 may perform a process to specify setting values for items of print settings during the process of uploading label data and may include the setting values specified for the print settings in this process as part of the label data being uploaded so that the delivery server 1 stores the label data including the print settings. This method simplifies the process of associating label data with print settings data by eliminating the need to store association data and print settings data separately from the label data. On the other hand, by storing label data and print settings data on the delivery server 1 as separate files, a single set of print settings data can be associated with a plurality of sets of label data.

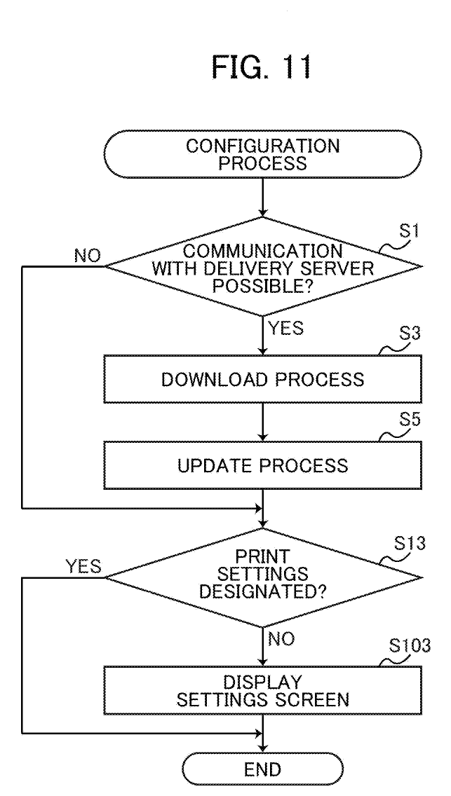

In the configuration process illustrated in FIG. 10, for example, the printing app 32 displays the settings screen (S11, S13: YES), even when print settings have been specified. In a variation of this configuration process illustrated in FIG. 11, for example, the printing app 32 may end the configuration process without displaying the settings screen when print settings have been specified (S13: YES). However, when print settings have not been specified (S13: NO), in S103 the printing app 32 may display the settings screen and receive print settings. Thus, when executing printing based on label data downloaded together with print settings, the printing app 32 does not display the settings screen on the destination PC 3 but executes printing using the downloaded print settings to prevent the user of the destination PC 3 from changing the specified print settings.

Furthermore, S15 may be omitted from the process of FIG. 10, for example. However, when executing printing based on label data that has been downloaded together with print settings, the printing app 32 enables the operator to check the print settings by displaying the settings screen with the downloaded print settings as initial values. Furthermore, since the printing app 32 executes printing with the downloaded print settings when the print settings have not been changed, the printing app 32 can be expected to execute printing using the print settings intended by the administrator who has uploaded the label data.

S17 and S19 may also be omitted from the process of FIG. 10, for example. However, when executing printing based on label data that has been downloaded together with print settings, the printing app 32 increases the likelihood that the printing results will be in line with the intention of the person who has uploaded the label data by prohibiting any operations for changing the downloaded print settings. Furthermore, by prohibiting operations to change print settings when the permission data indicates that changes are not permitted, any changes to print settings in the printing app 32 can be controlled in accordance with the administrator’s intention.

S1 through S5 may also be omitted from the process in FIG. 10, for example. However, by periodically downloading designated label data and specified print settings, the printing app 32 can reflect any updates the administrator has made to the designated label data and the specified print settings on the destination PC 3.

In any of the sequence diagrams and flowcharts disclosed in the embodiment, any of the plurality of processes may be executed in parallel, or the order in which the processes are performed may be modified in any way that does not produce inconsistencies in those processes. For example, the order in which print settings and label data are stored or the order in which label data and print settings are specified when specifying target labels for delivery may differ from those in the above embodiment.

The processes disclosed in the above embodiment may be executed by a single CPU, a plurality of CPUs, an ASIC or other hardware, or a combination of these components. Furthermore, the processes disclosed in the embodiment may be achieved through a storage medium that stores the programs used to implement those processes or according to any of various other methods or formats.

What is claimed is:

1. A delivery server connectable to a network, the delivery server comprising:
a controller configured to perform:
receiving a specification of a print setting from a source device connected to the network, the print setting being specified based on capabilities of a printer;
receiving uploading of label data from the source device connected to the network;
storing the label data and the specified print setting in association with each other; and
delivering, to a destination device connected to the network, the label data and the specified print setting associated with the label data.

2. The delivery server according to claim 1,
wherein the controller is configured to further perform:
identifying one or more printers connected to the network,
wherein the controller receives the specified print setting specified based on the capabilities of the printer selected from among the one or more printers identified by the identifying.

3. The delivery server according to claim 1,
wherein the controller is configured to store one or more print settings, each of the one or more print settings being a print setting specified based on the capabilities of the printer, and
wherein the controller receives the specification of the print setting specified from among the one or more print settings.

4. The delivery server according to claim 3,
wherein the controller is configured to further perform:
identifying one or more printers connected to the network;
receiving, from the source device connected to the network, a designation of the printer and a specification of the one or more print settings, the printer being designated from among the one or more printers identified by the identifying; and
storing the one or more print settings received from the source device connected to the network.

5. The delivery server according to claim 1,
wherein the controller performs the delivering in response to receiving, from the destination device, a delivery request designating a set of label data from among one or more sets of label data that have been stored by the storing, and
wherein the controller performs the delivering by delivering the designated set of label data and the print setting associated with the designated set of label data.

6. The delivery server according to claim 1,
wherein the controller performs the delivering by delivering the label data and the specified print setting to the printer as the destination device.

7. The delivery server according to claim 1,
wherein the controller performs the storing by:
storing print setting data indicating the specified print setting;
storing the label data; and
storing association data associating the label data with the print setting data, and
wherein the controller performs the delivering by delivering, based on the association data, the label data and the print setting data associated with the label data.

8. The delivery server according to claim 1,
wherein the controller performs the storing by:
generating data including the label data and the specified print setting; and
storing the generated data, and
wherein the controller performs the delivering by delivering the generated data.

9. The delivery server according to claim 1,
wherein the specified print setting includes a setting value related to a resolution.

10. The delivery server according to claim 1,
wherein the specified print setting includes a setting value related to a sheet setting.

11. The delivery server according to claim 1,
wherein the specified print setting includes a setting value related to the number of copies.

12. The delivery server according to claim 1,
wherein the controller is configured to further perform:
receiving, from the source device connected to the network, a specification indicating whether changes to the specified print setting are permitted,
wherein the controller performs the storing by:
generating print setting data including the specified print setting and permission data, the permission data indicating the received specification; and
storing the print setting data generated by the generating in association with the label data, and
wherein the controller performs the delivering by delivering the label data and the print setting data associated with the label data.

13. A non-transitory computer-readable storage medium storing a set of computer-readable instructions for an information processing device connectable to a network to which a delivery server is connectable, the delivery server being configured to store one or more sets of label data and one or more print settings corresponding to the one or more sets of label data, each of the one or more sets of label data being stored in association with a corresponding one of the one or more print settings, the set of computer-readable instructions, when executed by a computer of the information processing device, causing the information processing device to perform:
a designating process including:
designating a set of label data from among the one or more sets of label data stored on the delivery server;
a download process including:
downloading, from the delivery server, the set of label data designated in the designating process and a print setting associated with the set of label data;
a storing process including:
storing the set of label data and the print setting downloaded in the download process in association with each other; and
a printing process including:
transmitting a print command to a printer, the print command causing the printer to execute printing based on the set of label data stored in the storing process using the print setting stored in association with the set of label data.

14. The non-transitory computer-readable storage medium according to claim 13,
wherein the set of computer-readable instructions, when executed by the computer, causes the information processing device to further perform:
in response to receiving, in a state where a printer is selected, a print instruction for target label data that is being edited:
when the target label data is not the set of label data stored in the storing process:
a configuration process including:
displaying a setting screen for receiving a print setting based on capabilities of the selected printer; and
receiving the print setting via the setting screen; and
a second printing process including:
transmitting a second print command to the selected printer, the second print command causing the selected printer to execute printing based on the target label data using the print setting received via the setting screen; and
when the target label data is the set of label data stored in the storing process:
the printing process without performing the configuration process.

15. The non-transitory computer-readable storage medium according to claim 13,
wherein the set of computer-readable instructions, when executed by the computer, causes the information processing device to further perform:
in response to receiving, in a state where a printer is selected, a print instruction for target label data:
when the target label data is the set of label data downloaded in the download process:
a configuration process including:
displaying a setting screen for receiving a print setting based on capabilities of the selected printer; and
receiving the print setting via the setting screen, and
wherein, in the configuration process, the displaying is performed by displaying the setting screen in which the print setting stored in association with the target label data in the storing process is displayed as an initial value.

16. The non-transitory computer-readable storage medium according to claim 15,
wherein, in the configuration process, a change operation on the setting screen is prohibited, the change operation being an operation to change the print setting displayed as the initial value in the setting screen.

17. The non-transitory computer-readable storage medium according to claim 15,
wherein the print setting downloaded from the delivery server in the download process includes permission data indicating whether changes to the print setting are permitted, and
wherein, in the configuration process, when the print setting includes the permission data indicating that changes to the print setting are not permitted, a change operation on the setting screen is prohibited, the change operation being an operation to change the print setting displayed as the initial value in the setting screen.

18. The non-transitory computer-readable storage medium according to claim 13,
wherein the set of computer-readable instructions, when executed by the computer, causes the information processing device to perform:
the download process periodically to update the set of label data and the print setting stored in the storing process.

19. The non-transitory computer-readable storage medium according to claim 18,
wherein the set of computer-readable instructions, when executed by the computer, causes the information processing device to further perform:
in response to receiving a print instruction for the set of label data downloaded in the download process:
when the information processing device is communicable with the delivery server:
the download process to update the set of label data and the print setting stored in the storing process; and
the printing process after performing the download process; and
when the information processing device is not communicable with the delivery server:
the printing process without performing the download process.
